(19) United States
(12) Patent Application Publication
(10) Pub. No.: US 2026/0052076 A1
(43) Pub. Date: Feb. 19, 2026

(54) MEASUREMENTS FOR BEAM PREDICTION IN A COMMUNICATION SYSTEM

(71) Applicant: HUAWEI TECHNOLOGIES CO., LTD., Shenzhen (CN)

(72) Inventors: Salah Eddine Hajri, Lund (SE); Thorsten Schier, Lund (SE); Majid Gerami, Lund (SE); Mehmet ILTER, Lund (SE); Yuan Li, Beijing (CN)

(73) Assignee: HUAWEI TECHNOLOGIES CO., LTD., Shenzhen (CN)

(21) Appl. No.: 19/369,857

(22) Filed: Oct. 27, 2025

Related U.S. Application Data
(63) Continuation of application No. PCT/CN2023/093355, filed on May 11, 2023.

(51) Int. Cl. H04L 41/16; H04B 7/06; H04W 24/10

(52) U.S. Cl. CPC H04L 41/16; H04B 7/06952; H04W 24/10

(57) ABSTRACT

A measurement solution for beam prediction in a communication system. A first communication device receives a measurement configuration for at least one AI/ML model for beam prediction from a second communication device. The measurement configuration indicates a first trigger value for measurement of at least one first resource in a first set of resources and at least one second resource in a second set of resources. The first set of resources is for an inference measurement of the AI/ML model and the second set of resources is for a monitoring measurement of the AI/ML model. Based on the received measurement configuration, the first communication device measures the first resource to obtain a first inference measurement report and measures the second resource to obtain a first monitoring measurement report for the AI/ML model.

### CROSS-REFERENCE TO RELATED APPLICATIONS

This application is a continuation of International Application No. PCT/CN2023/093355, filed on May 11, 2023, the disclosure of which is hereby incorporated by reference in its entirety.

### TECHNICAL FIELD

The embodiments relate to measurements for beam prediction in a communication system. Furthermore, the embodiments also relate to corresponding methods and a computer program.

### BACKGROUND

Artificial intelligence (AI) methods, such as machine learning (ML), have proven their worth in a multitude of fields, covering different problems, including classification, regression, pattern detection, dimensionality reduction and interaction with dynamic environments. ML models are capable of capturing non-trivial dependencies and patterns in the data, that conventional signal processing techniques, can be used in air interface, are incapable of leveraging. Consequently, exploiting their potential in the air interface of wireless communication networks could deliver non-negligible performance gains.

In this context, 3GPP agreed a study item in Rel-18, study on AI/ML for new Radio (NR) air interface, the potential enhancements, performance gain, general framework and standard impact that ML methods would entail on the air interface, in several important use cases, such as beam management, CSI reporting and positioning performance enhancements. It is also expected that ML-based methods would be leveraged in different features, both in the air interface and in the core network.

### SUMMARY

An objective of the embodiments is to provide a solution which mitigates or solves the drawbacks and problems of conventional solutions.

Another objective of the embodiments is to provide an improved solution for AI/ML model measurements for beam management such as beam prediction.

According to a first aspect, the above mentioned and other objectives are achieved with a first communication device configured to:
receive a measurement configuration for at least one artificial intelligence/machine learning (AI/ML) model for beam prediction from a second communication device, the measurement configuration indicating a first trigger value for measurement of at least one first resource in a first set of resources and at least one second resource in a second set of resources, where the first set of resources is for an inference measurement of the AI/ML model and the second set of resources is for a monitoring measurement of the AI/ML model; and
measure the first resource to obtain a first inference measurement report for the AI/ML model and measure the second resource to obtain a first monitoring measurement report for the AI/ML model.

An advantage of the first communication device according to the first aspect is that the network of the second communication device can dynamically define an association between inference and monitoring measurement resources for the AI/ML model by the use of a common trigger value. Thus, the network via the second communication device can trigger measurements and reporting for inference and monitoring data using the same trigger value. This implies high flexibility in defining resource association which enables separate or joint operations. Additionally, this flexibility may adapt inference and monitoring measurements, for beam prediction in time and/or spatial domains, depending on the actual radio conditions and the first communication device capabilities.

In an embodiment of a first communication device according to the first aspect, the measurement configuration further indicates the first resource in the first set of resources and the second resource in the second set of resources.

An advantage with this embodiment is that the measurement configuration also can be used to configure the inference and monitoring measurement resources.

In an embodiment of a first communication device according to the first aspect, the first set of resources and the second set of resources includes overlapping resources.

An advantage with this embodiment is that full flexibility in configuring inference and monitoring measurement resources is achieved. Given that the requirements in terms of measurement for inference and monitoring depend on device capabilities, model implementation, propagation conditions, host of the inference and/or monitoring function, full flexibility is needed so that all possible deployment scenarios are supported.

In an embodiment of a first communication device according to the first aspect, the first set of resources corresponds to a first set of beams and the second set of resources corresponds to a second set of beams.

An advantage with this embodiment is that different sets of beams are sounded, for monitoring and inference. Consequently, more direction, in azimuth and elevation are explored and better monitoring input can be collected for beam prediction.

In an embodiment of a first communication device according to the first aspect, the first set of beams and the second set of beams includes any one of: transmit beams of the second communication device, receive beams of the first communication device, and beams pairs where each beam pair includes a transmit beam of the second communication device and a receive beam of the first communication device.

An advantage with this embodiment is that different beam prediction implementations can be supported. Depending on the host of the AI/ML model inference, i.e., the first communication device or the second communication device, the available information on transmit (Tx) and receive (Rx) beams may vary. Consequently, supporting different definitions of the set of beams may adapt to different levels of side information exchange and beam prediction deployment scenarios.

In an embodiment of a first communication device according to the first aspect, the first communication device is configured to
receive the measurement configuration in a radio resource control (RRC).

An advantage with this embodiment is that the measurement configuration for inference and monitoring can be an independent information element in RRC configuration or included in other radio resource measurement configurations within RRC. Additionally, periodic measurements for inference and monitoring can be supported.

In an embodiment of a first communication device according to the first aspect, the first communication device is configured to:
measure the first resource in the first set of resources and the second resource in the second set of resources upon receiving an indication of the first trigger value.

An advantage with this embodiment is that in addition to supporting periodic measurements, aperiodic and semi-persistent inference and monitoring measurements can also be supported. Given the dynamic propagation conditions, for example with the first communication device as a mobile device, trigger-based measurements can be leveraged to adapt to the actual mobility pattern of the mobile device and possible blockage events.

In an embodiment of a first communication device according to the first aspect, the first communication device is configured to:
receive the indication of the first trigger value in a downlink control information (DCI).

An advantage with this embodiment is that the trigger for inference and/or monitoring measurements can be conveyed in a new or an adapted field in DCI. Given the reliability of the downlink control channel and the dynamic nature of DCI, fast adaptation of inference and monitoring measurements is thus possible.

In an embodiment of a first communication device according to the first aspect, the first communication device is configured to:
receive a new first trigger value in a medium access control control element (MAC CE) the new first trigger value indicating measurement of at least one resource different to the first resource in the first set of resources and the second resource in the second set of resources.

An advantage with this embodiment is that dynamic adaptation of the association between trigger, measurement resources for inference and measurement resources for monitoring, is possible. This can be leveraged so that measurements by means of the new first trigger value can be adapted to the actual ongoing channel conditions and any change in the mobility of the first communication device, e.g., change in speed or direction.

In an embodiment of a first communication device according to the first aspect, the first trigger value is given in a bit format.

An advantage with this embodiment is that an already existing DCI field can be repurposed to support the present inference and monitoring triggering, e.g., using a radio network temporary identifier (RNTI) dedicated for ML-based operations.

In an embodiment of a first communication device according to the first aspect, the first communication device is configured to:
transmit the first inference measurement report and the first monitoring measurement report to the second communication device.

An advantage with this embodiment is that the inference and monitoring reports can be conveyed in the same or different reporting resources, e.g., PUSCH or PUCCH. This provides flexibility in terms of resource allocation and management in reporting which e.g., reduces the risk of report omission.

In an embodiment of a first communication device according to the first aspect, the first inference measurement report includes any one of: a beam indicator or a resource indicator, a beam pair indicator or a resource pair indicator; and a reference signal received power, RSRP, or a signal-to-interference plus noise ratio, SINR, for the beam indicator or the resource indicator, the beam pair indicator or resource pair indicator.

An advantage with this embodiment is that it can support the prediction of transmit beams of the second communication device, receive beams of the first communication device, and beams pairs where each beam pair includes a transmit beam of the second communication device and a receive beam of the first communication device. Additionally, by supporting RSRP and SINR, received power and interference can be taken into consideration when performing beam prediction.

In an embodiment of a first communication device according to the first aspect, the first monitoring measurement report includes any one of: a model performance metric for the AI/ML model, a prediction of the AI/ML model, a beam indicator or a resource indicator, a beam pair indicator or a resource pair indicator; and a RSRP or a SINR for the beam indicator or the resource indicator, the beam pair indicator or resource pair indicator.

An advantage with this embodiment is that monitoring quantities computation can be performed at the first communication device or at the second communication device, based on reported measurements from the first communication device. Additionally, it is critical to support different monitoring methods since the beam prediction models can be quite different in terms of complexity and capabilities.

In an embodiment of a first communication device according to the first aspect, the first communication device is configured to:
transmit a second trigger value for the AI/ML model to the second communication device, the second trigger value indicating measurement of at least one first recommended resource in the first set of resources and at least one second recommended resource in the second set of resources.

An advantage with this embodiment is that the first communication device can dynamically request specific resource to measure for monitoring and inference. Alternately, such indication can be used as part of the monitoring and inference reports, in order to indicate which resource were actually measured by the first communication device. This implementation enables to leverage predictive capabilities at the first communication device which may improve the measurement accuracy and performance.

In an embodiment of a first communication device according to the first aspect, the first communication device is configured to:
measure the first recommended resource to obtain a second inference measurement report and measure the second recommended resource to obtain a second monitoring measurement report; and
transmit the second inference measurement report and the second monitoring measurement report to the second communication device.

An advantage with this embodiment is that the first communication device can transmit inference and monitoring measurement reports, based on measurements it made on the recommended resources and actually change recommended resources when needed. This may fully leverage any insights at the first communication device.

In an embodiment of a first communication device according to the first aspect, the first communication device is configured to:
determine the first recommended resource in the first set of resources and the second recommended resource in the second set of resources based on any one of: a resource selection algorithm, a measurement on a resource different to the first resource in the first set of resources and the second resource in the second set of resources, a location of the first communication device, a movement direction of first communication device, and a speed of the first communication device.

An advantage with this embodiment is that information at the first communication device can be leveraged to optimize measurements, for inference and monitoring, without requiring explicit disclosure to the second communication device. The recommendation or selection of measurement resources by the first communication device can be seen as an implicit side information which does not force a specific implementation for resource selection. Hence the advantages can be reaped with different device capabilities/implementations.

In an embodiment of a first communication device according to the first aspect, the first communication device is configured to:
transmit an adaptation message to the second communication device, the adaptation message indicating: a fallback model for the AI/ML model, a switch of the AI/ML model, or an update of the AI/ML model.

An advantage with this embodiment is that the first communication device can derive insights on the possible predictive model performance, from its measurements for inference and monitoring, and indicates subsequently proper model adaptation action when needed. For example, if the first communication device detects a drift in the measurement statistics, it can predict that the active beam prediction model cannot handle the data and adaptation may be needed. Depending on the implementation, the first communication device can adapt autonomously, or wait for an indication from the second communication device, in response to the adaptation message.

According to a second aspect, the above mentioned and other objectives are achieved with a second communication device configured to:
transmit a measurement configuration for at least one AI/ML model for beam prediction to a first communication device, the measurement configuration indicating a first trigger value for measurement of at least one first resource in a first set of resources and at least one second resource in a second set of resources, where the first set of resources is for an inference measurement of the AI/ML model and the second set of resources is for a monitoring measurement of the AI/ML model.

An advantage of the second communication device according to the second aspect is that the network of the second communication device can dynamically define an association between inference and monitoring measurement resources for the AI/ML model by the use of a common trigger value. Thus, the network via the second communication device can trigger measurements and reporting for inference and monitoring data using the same trigger value. This implies high flexibility in defining resource association which enables separate or joint operations. Additionally, this flexibility may adapt inference and monitoring measurements, for beam prediction in time and/or spatial domains, depending on the actual radio conditions and the first communication device capabilities.

In an embodiment of a second communication device according to the second aspect, the measurement configuration further indicates the first resource in the first set of resources and the second resource in the second set of resources.

An advantage with this embodiment is that the measurement configuration also can be used to configure the inference and monitoring measurement resources.

In an embodiment of a second communication device according to the second aspect, the first set of resources and the second set of resources includes overlapping resources.

An advantage with this embodiment is that full flexibility in configuring inference and monitoring measurement resources is achieved. Given that the requirements in terms of measurement for inference and monitoring depend on device capabilities, model implementation, propagation conditions, host of the inference and/or monitoring function, full flexibility is needed so that all possible deployment scenarios are supported.

In an embodiment of a second communication device according to the second aspect, the first set of resources corresponds to a first set of beams and the second set of resources corresponds to a second set of beams.

An advantage with this embodiment is that different sets of beams are sounded, for monitoring and inference. Consequently, more direction, in azimuth and elevation are explored and better monitoring input can be collected for beam prediction.

In an embodiment of a second communication device according to the second aspect, the first set of beams and the second set of beams includes any one of: transmit beams of the second communication device, receive beams of the first communication device, and beams pairs where each beam pair includes a transmit beam of the second communication device and a receive beam of the first communication device.

An advantage with this embodiment is that different beam prediction implementations can be supported. Depending on the host of the AI/ML model inference, i.e., the first communication device or the second communication device, the available information on Tx and Rx beams may vary. Consequently, supporting different definitions of the set of beams may adapt to different levels of side information exchange and beam prediction deployment scenarios.

In an embodiment of a second communication device according to the second aspect, the second communication device is configured to:
transmit the measurement configuration in a RRC to the first communication device.

An advantage with this embodiment is that the measurement configuration for inference and monitoring can be an independent information element in RRC configuration or included in other radio resource measurement configurations within RRC. Additionally, periodic measurements for inference and monitoring can be supported.

In an embodiment of a second communication device according to the second aspect, the second communication device is configured to:
transmit an indication of the first trigger value in a DCI to the first communication device.

An advantage with this embodiment is that the trigger for inference and/or monitoring measurements can be conveyed in a new or an adapted field in DCI. Given the reliability of the downlink control channel and the dynamic nature of DCI, fast adaptation of inference and monitoring measurements is thus possible.

In an embodiment of a second communication device according to the second aspect, the second communication device is configured to:
transmit a new first trigger value in a MAC CE to the first communication device, the new first trigger value indicating measurement of at least one resource different to the first resource in the first set of resources and the second resource in the second set of resources.

An advantage with this embodiment is that dynamic adaptation of the association between trigger, measurement resources for inference and measurement resources for monitoring, is possible. This can be leveraged so that measurements by means of the new first trigger value can be adapted to the actual ongoing channel conditions and any change in the mobility of the first communication device, e.g., change in speed or direction.

In an embodiment of a second communication device according to the second aspect, the first trigger value is given in a bit format.

An advantage with this embodiment is that an already existing DCI field can be repurposed to support the present inference and monitoring triggering, e.g., using a RNTI dedicated for ML-based operations.

In an embodiment of a second communication device according to the second aspect, the second communication device is configured to:
receive a first inference measurement report and a first monitoring measurement report from the first communication device, the first inference measurement report being based on a measurement of the first resource and the first monitoring measurement report being based on measurement of the second resource.

An advantage with this embodiment is that the inference and monitoring reports can be conveyed in the same or different reporting resources, e.g., PUSCH or PUCCH. This provides flexibility in terms of resource allocation and management in reporting which e.g., reduces the risk of report omission.

In an embodiment of a second communication device according to the second aspect, the first inference measurement report includes any one of: a beam indicator or a resource indicator, a beam pair indicator or a resource pair indicator; and a RSRP or a SINR for the beam indicator or the resource indicator, the beam pair indicator or resource pair indicator.

An advantage with this embodiment is that it can support the prediction of transmit beams of the second communication device, receive beams of the first communication device, and beams pairs where each beam pair includes a transmit beam of the second communication device and a receive beam of the first communication device. Additionally, by supporting RSRP and SINR, received power and interference can be taken into consideration when performing beam prediction.

In an embodiment of a second communication device according to the second aspect, the first monitoring measurement report includes any one of: a model performance metric for the AI/ML model, a prediction of the AI/ML model, a beam indicator or a resource indicator, a beam pair indicator or a resource pair indicator; and a RSRP or a SINR for the beam indicator or the resource indicator, the beam pair indicator or resource pair indicator.

An advantage with this embodiment is that monitoring quantities computation can be performed at the first communication device or at the second communication device, based on reported measurements from the first communication device. Additionally, it is critical to support different monitoring methods since the beam prediction models can be quite different in terms of complexity and capabilities.

In an embodiment of a second communication device according to the second aspect, the second communication device is configured to:
receive a second trigger value for the AI/ML model from the first communication device, the second trigger value indicating measurement of at least one first recommended resource in the first set of resources and at least one second recommended resource in the second set of resources.

An advantage with this embodiment is that the first communication device can dynamically request specific resource to measure for monitoring and inference. Alternately, such indication can be used as part of the monitoring and inference reports, in order to indicate which resource were actually measured by the first communication device. This implementation enables to leverage predictive capabilities at the first communication device which may improve the measurement accuracy and performance.

In an embodiment of a second communication device according to the second aspect, the second communication device is configured to:
receive a second inference measurement report and a second monitoring measurement report from the first communication device, the second inference measurement report being based on a measurement of the first recommended resource and the second monitoring measurement report being based on a measurement of the second recommended resource.

An advantage with this embodiment is that the first communication device can transmit inference and monitoring measurement reports, based on measurements it made on the recommended resources and actually change recommended resources when needed. This may fully leverage any insights at the first communication device.

In an embodiment of a second communication device according to the second aspect, the second communication device is configured to:
receive an adaptation message from the first communication device, the adaptation message indicating: a fallback model for the AI/ML model, a switch of the AI/ML model, or an update of the AI/ML model; and
adapt the AI/ML model based on the adaptation message.

An advantage with this embodiment is that the first communication device can derive insights on the possible predictive model performance, from its measurements for inference and monitoring, and indicates subsequently proper model adaptation action when needed. For example, if the first communication device detects a drift in the measurement statistics, it can predict that the active beam prediction model cannot handle the data and adaptation may be needed. Depending on the implementation, the first communication device can adapt autonomously, or wait for an indication from the second communication device, in response to the adaptation message.

According to a third aspect, the above mentioned and other objectives are achieved with a method for a first communication device, the method includes:
receiving a measurement configuration for at least one AI/ML model for beam prediction from a second communication device, the measurement configuration indicating a first trigger value for measurement of at least one first resource in a first set of resources and at least one second resource in a second set of resources, where the first set of resources is for an inference measurement of the AI/ML model and the second set of resources is for a monitoring measurement of the AI/ML model; and
measuring the first resource to obtain a first inference measurement report for the AI/ML model and measure the second resource to obtain a first monitoring measurement report for the AI/ML model.

The method according to the third aspect can be extended into embodiments corresponding to the embodiments of the first communication device according to the first aspect. Hence, an embodiment of the method includes the feature(s) of the corresponding embodiment of the first communication device.

The advantages of the methods according to the third aspect are at least the same as those for the corresponding embodiments of the first communication device according to the first aspect.

According to a fourth aspect, the above mentioned and other objectives are achieved with a method for a second communication device, the method includes:
transmitting a measurement configuration for at least one AI/ML model for beam prediction to a first communication device, the measurement configuration indicating a first trigger value for measurement of at least one first resource in a first set of resources and at least one second resource in a second set of resources, where the first set of resources is for an inference measurement of the AI/ML model and the second set of resources is for a monitoring measurement of the AI/ML model.

The method according to the fourth aspect can be extended into embodiments corresponding to the embodiments of the second communication device according to the second aspect. Hence, an embodiment of the method includes the feature(s) of the corresponding embodiment of the second communication device.

The advantages of the methods according to the fourth aspect are the same as those for the corresponding embodiments of the second communication device according to the second aspect.

The embodiments also relate to a computer program, characterized in program code, which when run by at least one processor causes the at least one processor to execute any method according to the embodiments. Further, the embodiments also relate to a computer program product including a non-transitory computer readable medium and the mentioned computer program, where the computer program is included in the non-transitory computer readable medium, and may include one or more of: read-only memory (ROM), programmable ROM (PROM), erasable PROM (EPROM), flash memory, electrically erasable PROM (EEPROM), hard disk drive, etc.

Further applications and advantages of the embodiments will be apparent from the following detailed description.

### BRIEF DESCRIPTION OF DRAWINGS

The appended drawings are intended to clarify and explain different embodiments, in which:

FIG. 1 shows a first communication device according to an embodiment;

FIG. 2 shows a flow chart of a method for a first communication device according to an embodiment;

FIG. 3 shows a second communication device according to an embodiment;

FIG. 4 shows a flow chart of a method for a second communication device according to an embodiment;

FIG. 5 shows a communication system according to an embodiment;

FIG. 6 illustrates different resources used for inference and monitoring measurements;

FIG. 7 shows a signaling diagram between a first communication device and a second communication device according to an embodiment; and

FIGS. 8 and 9 illustrates interaction between a network via a TRP and a UE according to embodiments.

### DETAILED DESCRIPTION OF EMBODIMENTS

As aforementioned an AL/ML model(s) may be used for beam management, such as beam prediction in communication systems. In this respect several aspects need to be considered such as model training, model adaptation, model performance monitoring, training and inference data collection, model transfer, user equipment (UE) capability, model update, selection, activation, deactivation, switching and fallback operation.

While ML/AI models for beam management could deliver substantial performance gains, some hurdles need to be considered, including complexity, power consumption and latency. Indeed, the operations in the physical layer of cellular networks are subject to stringent latency requirements, which is one of the most critical aspects of a high-performance air interface. A set of key performance indicators (KPIs) and metrics is considered in order to assess performance, over-the-air overhead, inference complexity, training complexity, latency, and storage overhead.

In the high frequency ranges, the beams used for transmission and reception are narrow to guarantee coverage. This leads to an increase in the number of potential beams and the subsequent reference signal (RS) overhead and measurement load. The AI/ML model can be used to reduce measurement requirements by predicting beams in the spatial domain. By learning the spatial channel characteristics, the AI/ML model may derive the optimal beam, from a narrow beam codebook, based on limited RS resource measurements which may be transmitted with narrow or sparse/wide beams. Beam prediction in the time domain is also considered in order to better handle UE mobility. Depending on the UE mobility pattern and velocity, the optimal beam would vary over time and the rate of this change of beam depends on the beam design, UE mobility pattern and velocity, among others. In order to keep track of the optimal beam in the time domain, RS measurements are performed, in the downlink (DL), in the uplink (UL) or both in the DL and UL.

Beam sweeping overhead and latency are critical for networks operating in high frequency ranges e.g., in FR2. Indeed, narrow beams are needed to maintain coverage and guarantee link quality. However, the narrower the beams, the costlier it is to select the optimal beams given that beam measurements and RS overhead scale accordingly. Using AI/ML models, the network is able to derive the channel spatial characteristics and subsequently optimize its beam sweeping so that the top beams for a given UE are derived from a reduced number of DL RS measurements.

In order to guarantee the performance of active models, for beam and CSI prediction, and to be able to perform model adaptation actions, monitoring is thus a critical aspect of AI/ML model's life cycle management. Monitoring can be performed at the UE-side, the network-side or in a hybrid manner. Additionally, different monitoring metrics and benchmarks can be considered. In either case, monitoring quantities require prior measurements on resources other than those used to collect inference input. Further, it is critical to maintain monitoring measurements to a minimum while guaranteeing the proper operation of the model monitoring process. Consequently, it would be counter-productive to measure the whole set A of beams for the sake of monitoring as this would hinder the gains that could be obtained from AI/ML-based beam management.

Thus, a solution for inference measurements and monitoring measurements configuration and triggering for beam prediction suitable for AI/ML model based air interface operations is provided in the embodiments.

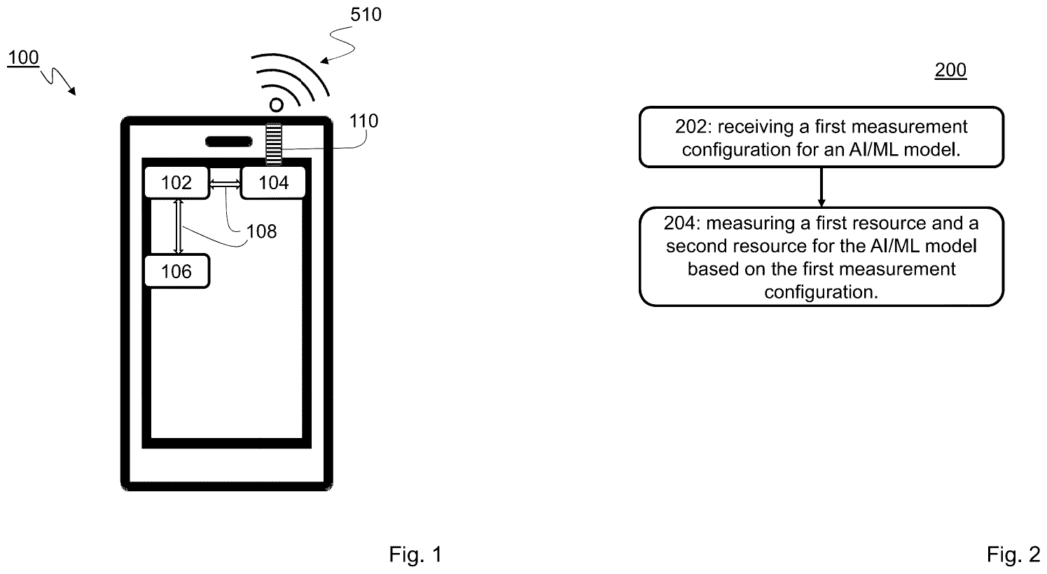

FIG. 1 shows a first communication device 100 according to an embodiment. In the embodiment shown in FIG. 1, the first communication device 100 includes a processor 102, a transceiver 104 and a memory 106. The processor 102 is coupled to the transceiver 104 and the memory 106 by communication means 108 known in the art. The first communication device 100 may be configured for wireless and/or wired communications in a communication system. The wireless communication capability may be provided with an antenna or antenna array 110 coupled to the transceiver 104, while the wired communication capability may be provided with a wired communication interface 112 e.g., coupled to the transceiver 104.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random access memory (RAM), or a non-volatile RAM (NVRAM). The transceiver 304 may be a transceiver circuit, a power controller, or an interface providing capability to communicate with other communication modules or communication devices, such as network nodes and network servers. The transceiver 104, memory 106, and/or processor 102 may be implemented in separate chipsets or may be implemented in a common chipset.

That the first communication device 100 is configured to perform certain actions can, in the embodiments, be understood to mean that the first communication device 100 includes suitable means, such as e.g., the processor 102 and the transceiver 104, configured to perform the actions.

According to the embodiments, the first communication device 100 is configured to: receive a measurement configuration 510 for at least one AI/ML model for beam prediction from a second communication device 300, the measurement configuration 510 indicating a first trigger value for measurement of at least one first resource Bn in a first set of resources B and at least one second resource Mn in a second set of resources M, where the first set of resources B is for an inference measurement of the AI/ML model and the second set of resources M is for a monitoring measurement of the AI/ML model; and measure the first resource Bn to obtain a first inference measurement report 532 for the AI/ML model and measure the second resource Mn to obtain a first monitoring measurement report 534 for the AI/ML model.

Furthermore, in an embodiment, the first communication device 100 includes a transceiver configured to: receive a measurement configuration 510 for at least one AI/ML model for beam prediction from a second communication device 300, the measurement configuration 510 indicating a first trigger value for measurement of at least one first resource Bn in a first set of resources B and at least one second resource Mn in a second set of resources M, where the first set of resources B is for an inference measurement of the AI/ML model and the second set of resources M is for a monitoring measurement of the AI/ML model. The first communication device 100 includes a processor configured to: measure the first resource Bn to obtain a first inference measurement report 532 for the AI/ML model and measure the second resource Mn to obtain a first monitoring measurement report 534 for the AI/ML model.

Moreover, in yet another embodiment, the first communication 100 for a communication system 500 includes a processor and a memory having computer readable instructions stored thereon which, when executed by the processor, cause the processor to: receive a measurement configuration 510 for at least one AI/ML model for beam prediction from a second communication device 300, the measurement configuration 510 indicating a first trigger value for measurement of at least one first resource Bn in a first set of resources B and at least one second resource Mn in a second set of resources M, where the first set of resources B is for an inference measurement of the AI/ML model and the second set of resources M is for a monitoring measurement of the AI/ML model. The first communication device 100 includes a processor configured to: measure the first resource Bn to obtain a first inference measurement report 532 for the AI/ML model and measure the second resource Mn to obtain a first monitoring measurement report 534 for the AI/ML model.

FIG. 2 shows a flow chart of a corresponding method 200 which may be executed in a first communication device 100, such as the one shown in FIG. 1. The method 200 includes: receiving 202 a measurement configuration 510 for at least one AI/ML model for beam prediction from a second communication device 300, the measurement configuration 510 indicating a first trigger value for measurement of at least one first resource Bn in a first set of resources B and at least one second resource Mn in a second set of resources M, where the first set of resources B is for an inference measurement of the AI/ML model and the second set of resources M is for a monitoring measurement of the AI/ML model; and measuring 204 the first resource Bn to obtain a first inference measurement report 532 for the AI/ML model and measure the second resource Mn to obtain a first monitoring measurement report 534 for the AI/ML model.

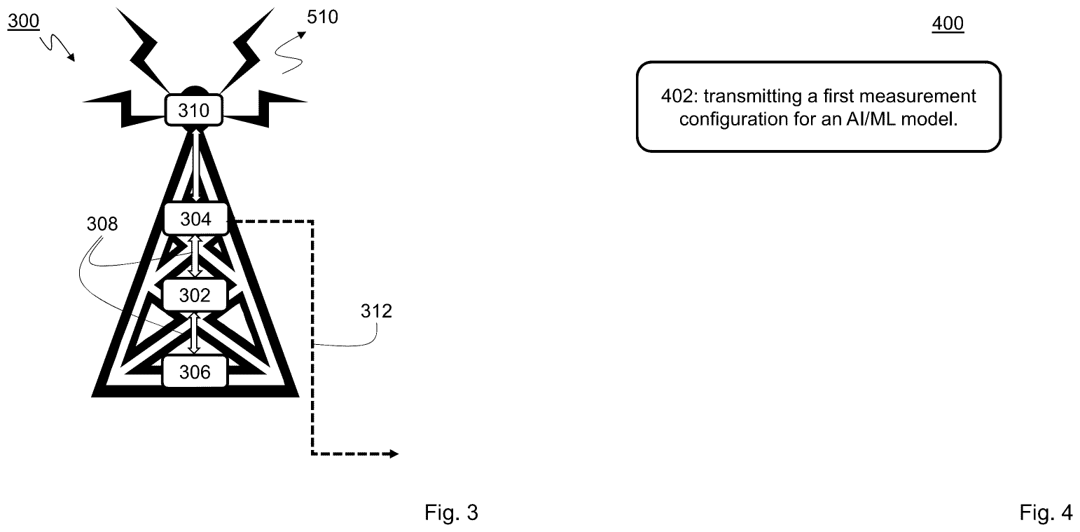

FIG. 3 shows a second communication device 300 according to an embodiment. In the embodiment shown in FIG. 3, the second communication device 300 includes a processor 302, a transceiver 304 and a memory 306. The processor 302 is coupled to the transceiver 304 and the memory 306 by communication means 308 known in the art. The second communication device 300 further includes an antenna or antenna array 310 coupled to the transceiver 304, which means that the second communication device 300 is configured for wireless communications in a communication system.

The processor 302 may be referred to as one or more general-purpose CPUs, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 104 may be a transceiver circuit, a power controller, or an interface providing capability to communicate with other communication modules or communication devices. The transceiver 304, the memory 306 and/or the processor 302 may be implemented in separate chipsets or may be implemented in a common chipset.

That the second communication device 300 is configured to perform certain actions can, in the embodiments, be understood to mean that the second communication device 300 includes suitable means, such as e.g., the processor 302 and the transceiver 304, configured to perform the actions.

According to the embodiments, the second communication device 300 is configured to: transmit a measurement configuration 510 for at least one AI/ML model for beam prediction to a first communication device 100, the measurement configuration 510 indicating a first trigger value for measurement of at least one first resource Bn in a first set of resources B and at least one second resource Mn in a second set of resources M, where the first set of resources B is for an inference measurement of the AI/ML model and the second set of resources M is for a monitoring measurement of the AI/ML model.

Furthermore, in an embodiment, the second communication device 300 for a communication system 500 includes a transceiver configured to: transmit a measurement configuration 510 for at least one AI/ML model for beam prediction to a first communication device 100, the measurement configuration 510 indicating a first trigger value for measurement of at least one first resource Bn in a first set of resources B and at least one second resource Mn in a second set of resources M, where the first set of resources B is for an inference measurement of the AI/ML model and the second set of resources M is for a monitoring measurement of the AI/ML model.

Moreover, in yet another embodiment, the second communication device 300 for a communication system 500 includes a processor and a memory having computer readable instructions stored thereon which, when executed by the processor, cause the processor to: transmit a measurement configuration 510 for at least one AI/ML model for beam prediction to a first communication device 100, the measurement configuration 510 indicating a first trigger value for measurement of at least one first resource Bn in a first set of resources B and at least one second resource Mn in a second set of resources M, where the first set of resources B is for an inference measurement of the AI/ML model and the second set of resources M is for a monitoring measurement of the AI/ML model.

FIG. 4 shows a flow chart of a corresponding method 400 which may be executed in a second communication device 300, such as the one shown in FIG. 3. The method 400 includes: transmitting 402 a measurement configuration 510 for at least one AI/ML model for beam prediction to a first communication device 100, the measurement configuration 510 indicating a first trigger value for measurement of at least one first resource Bn in a first set of resources B and at least one second resource Mn in a second set of resources M, where the first set of resources B is for an inference measurement of the AI/ML model and the second set of resources M is for a monitoring measurement of the AI/ML model.

Further details related to the different embodiments will now be described in a 3GPP 5G context with reference to the appended Figs. Thus, 3GPP 5G terminology, definitions, expressions and system architecture may be used. It may however be noted that the embodiments are not limited thereto.

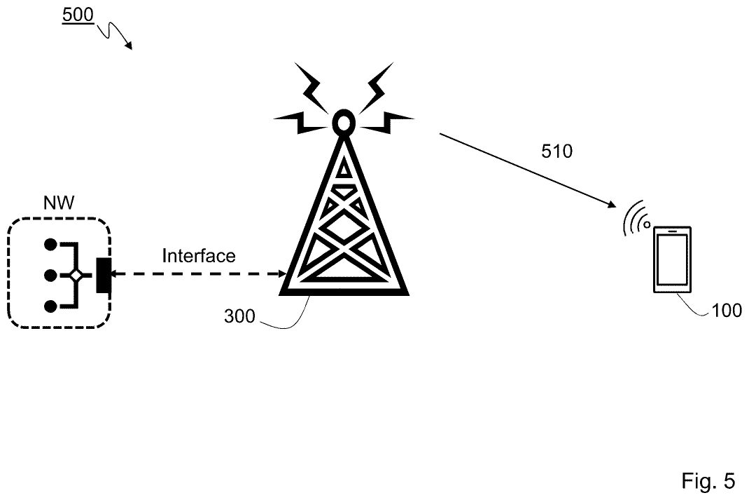

FIG. 5 shows a communication system 500 according to the embodiments. The communication system 500 in the embodiment includes a first communication device 100 and a second communication device 300 configured to communicate and operate in the communication system 500. In the shown embodiment, the first communication device 100 is configured as a client device and the second communication device 300 is configured as a network access node. However, in embodiments the first communication device 100 may instead be configured as a network access node and the second communication device 300 may be configured as a client device or both the first communication device 100 and the second communication device 300 may be configured as client devices.

A communication device 100, 300 being a network access node may be connected to a network NW such as e.g., a core network over a communication interface. The communication system 500 may be a communication system according to the 3GPP standard such as e.g., a 5G system in which case the client device may be a UE and the network access node may be next generation node B (gNBs) but the embodiments are not limited thereto. The first communication devices 100 and the second communication devices 300 are configured to communicate with each other over radio channels. The radio channels may be used for one or more of UL, DL, and sidelink (SL) communication depending on whether the first communication device 100 and the second communication device 300 are client devices and/or network access nodes. In case of a 5G system, the uplink/downlink communication may be performed over the Uu interface and the sidelink communication over the PC5 interface.

AI/ML models may be used for communication sessions over the radio channels between the first communication device 100 and the second communication device 300. The AUML models may e.g., be used to perform physical layer operations such as CSI reporting, radio resource measurements enhancements, positioning reference signals measurements, beam measurements, power control, etc. Given the client device mobility and the dynamic nature of radio channels and traffic characteristics, the performance of an AI/ML model used to perform physical layer operations may degrade over time or fall below target performance. Input drift due to change in the large-scale parameters of the radio channel, e.g., spatial and delay supports, or change in the traffic requirements may necessitate a change in link adaptation, radio resources measurements, resource allocation policies, among others, and subsequently an adaptation of the active AI/ML models.

This is also relevant for beam management using one or more AI/ML models in the communication system 500 according to the embodiments. To optimize beam management and beam prediction reliable measurements of resources corresponding to the beams are needed. Such measurements may be used as input to the one or more AI/ML models for beam prediction.

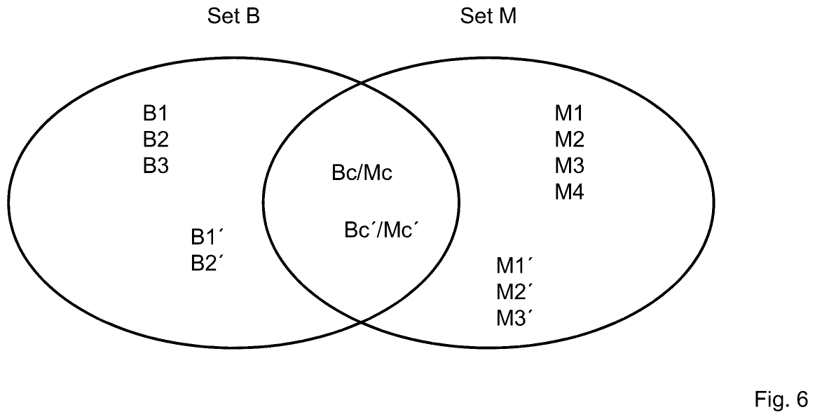

FIG. 6 illustrates different resources that may be used for inference and monitoring measurements for one or more AI/ML models according to the embodiments. The resources mentioned herein may in general terms be understood as reference signal resources, which can be DL reference signal resources, e.g., channel state information reference signal (CSI-RS) synchronization signal block (SSB), UL reference signals resources, e.g., sounding reference signal (SRS), sidelink reference signal resources, etc. The resources may be continuous or discontinuous over the frequency range.

The first set of resources B and the second set of resources M may in examples includes exclusive set of resources which are not overlapping but may in other examples include one or more overlapping resources as shown in FIG. 6. The non-limiting example illustrated in FIG. 6 shows the first set B including the exclusive subsets B1, B2, B3 while the second set M includes the exclusive subsets M1, M2, M3, M4. The first B and second M sets also have common resources i.e., overlapping resources denoted Bc/Mc. Thus, flexibility is provided for selecting the relevant resources for inference and monitoring measurements in the communication system depending on the scenario.

It is further noted that the resources of set B and M correspond to radio beams for transmission and/or reception of communication signals e.g., over an air-interface. Thus, the first set of resources B corresponds to a first set of beams and the second set of resources M corresponds to a second set of beams according to the embodiments. The first and second set of beams may also be exclusive or partially overlapping as previously mentioned in the case of first B and second M sets of resources. Further, it is realized that there are different types of beams and hence the first set of beams and the second set of beams may include any of: transmit beams of the second communication device 300 for radio transmission, receive beams of the first communication device 100 for radio reception, and then beams pairs where each beam pair includes a transmit beam of the second communication device 300 and a receive beam of the first communication device 100.

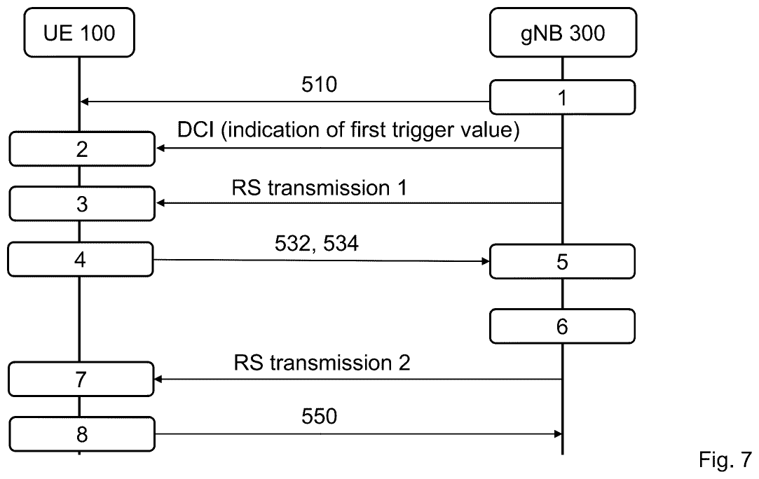

To provide an even deeper understanding of further embodiments, FIG. 7 shows the signaling between the first communication device 100, in this case acting as a UE 100, and the second communication device 300, in this case acting as a base station such as a gNB 300.

In step (or operation) 1 in FIG. 7, the gNB 300 transmits a measurement configuration 510 to the UE 100. As aforementioned, the measurement configuration 510 indicates the first trigger value which associates measurement resources for inference and monitoring measurement. However, the measurement configuration 510 may also indicate the first resource Bn in the first set of resources B and the second resource Mn in the second set of resources M to be measured by the UE 100. The first resource Bn and the second resource may in other examples be preconfigured in the UE 100 or previously configured by the network.

The measurement configuration 510 may be transmitted in radio resource control (RRC) signaling in the DL to the UE 100 for semi-static configuration of the UE 100. The network via the gNB 300 may configure or reconfigure the UE 100 one or more times by transmitting one more measurement configurations 510 to the UE 100 indicating one or more first trigger values thus associating a plurality of different resources for inference with resources for monitoring.

The UE 100 receives the measurement configuration 510 and derives the information about the association between the first resource Bn, the second resource Mn and the first trigger value from the measurement configuration 510.

In step (or operation) 3 in FIG. 7, the UE 100 measures the first resource Bn and the second resource Mn upon receiving an indication of the first trigger value, in step (or operation) 2 in FIG. 7, according to the embodiments. Based on the measurements of the first resource Bn and the second resource Mn, the UE 100 determines a first inference measurement report 532 and a first monitoring measurement report 534. The first resource Bn and the second resource Mn may be transmitted as a first RS transmission from the gNB 300.

The indication of the first trigger value may be received in downlink control information (DCI) from the gNB 300. In the embodiments, the first trigger value is given in a bit format as illustrated in Table 1. Bits “00” associates resources B1, M1 with M2; bits “01” associates resources B2, B1 with M3; bits “10” associates resources B0 to B7 with M0 to M4; and bits “11” associates resources B1, B2, Bc with the Mc where Bc and Mc is the same resource for inference and monitoring. Thus, it may be derived from Table 1 that a trigger value associates resources for inference and monitoring measurements, respectively, with each other. Therefore, for each first trigger value the UE 100 knows which associated resources are to be measured. In this respect it may also be noted that the measurement configuration 510 may indicate more than one first trigger value. For example, the measurement configuration 510 could indicate all the first trigger values given in Table 1.

TABLE 1

| | | Trigger value |
|---|---|---|
| Set B | Set M | in DCI |
| Set B1 | Set M1, Set M2 | 00 |
| Set B1, Set B2 | Set M3 | 01 |
| Set B0 . . . B7 | Set M0 . . . M4 | 10 |
| Set B1, Set B2, Bc | Mc | 11 |

In step (or operation) 4 in FIG. 7, the UE 100 transmits the first inference measurement report 532 and the first monitoring measurement report 534 to the gNB 300. This may be performed in the UL in e.g., uplink control information (UCI). Further, the reporting of the inference measurement report 532 and the first monitoring measurement report 534 may be performed in the same or different UL resources e.g., depending on reporting timeline and configured reporting resources. Thus, the reporting may be performed in the same or different UCI in the physical uplink control channel (PUCCH) or in the physical uplink shared channel (PUSCH).

The measurement reports may include different information elements depending on the application. Therefore, the first inference measurement report 532 includes one or more of:

A beam indicator or a resource indicator, a beam pair indicator or a resource pair indicator.

A reference signal received power (RSRP) or a signal-to-interference plus noise ratio (SINR) for the beam indicator or the resource indicator, the beam pair indicator or resource pair indicator.

Thus, the prediction of transmit or receive beams of the UE, the transmit or receive beams of the gNB, and the beams pairs can be supported. Additionally, by supporting RSRP and SINR, received power and interference can be taken into consideration when performing the beam prediction.

The first monitoring measurement report 534 may include the same information elements as the information elements in the first inference measurement report 532 but with the addition of a model performance metric for the AI/ML model and a prediction of an AI/ML model. Indeed, there is different approaches for model monitoring. Model performance metrics can e.g., use beam prediction accuracy, RSRP prediction accuracy, RSRP mean squared error, etc. Otherwise, predictions obtained from different AI/ML models or beam determination policies can be used as benchmarks to quantify the active AI/ML model performance.

In step (or operation) 5 in FIG. 7, the gNB 300 receives the first inference measurement report 532 and the first monitoring measurement report 534 from the UE 100 and processes the received measurement information. The gNB 300 may use the received measurement information in a number of different ways depending on the application and scenario. For example, if the final beam prediction is done at the UE 100, then the inference measurements may be used as input for a beam prediction AI/ML model and the monitoring measurements may be used to assess the AI/ML model performance. In other examples these measurement reports may be used as information for AI/ML model life cycle management such as model adaptation, fallback model, model switching, etc.

In step (or operation) 6 in FIG. 7, the inference measurement report can be used as input for a beam or beam pair prediction AI/ML model at the gNB 300. In this case, the gNB 300 can predict the top-K beams or beam pairs from narrow beams codebook and use them to transmit other RS resources for the UE 100 to measure. K is an integer and may be defined by a communication standard. This operation can be done when the possible output space, i.e., codebook of narrow beam or beam pairs, is of a large size relative to the measured resources for inference.

In step (or operation) 7 in FIG. 7, the UE 100 measures resources that convey the predicted top-K beams or beam pairs, by the network, and identifies the best beam based on a second RS transmission from the gNB 300.

Furthermore, an AI/ML adaption mechanism may also be provided in which the UE 100 transmits an adaptation message 550 to the gNB 300 as shown in step (or operation) 8 in FIG. 7. The adaptation message 550 indicates any of:

A fallback for the AI/ML model which may be understood as switching from beam management based on prediction to beam management based solely on measurements, i.e., to the conventional beam management without ML-based operations.

A switch of the AI/ML model where a change in the active AI/ML beam prediction model is notified or requested.

An update of the AI/ML model where one or multiple of the model parameters and/or coefficients are changed in order to adapt the AI/ML model based on the latest measurements of the UE 100.

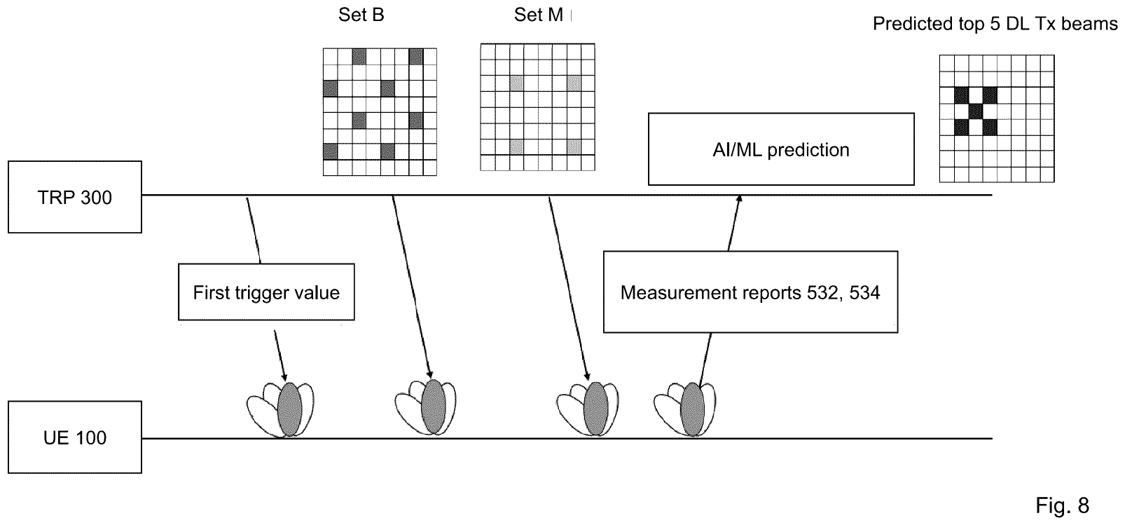

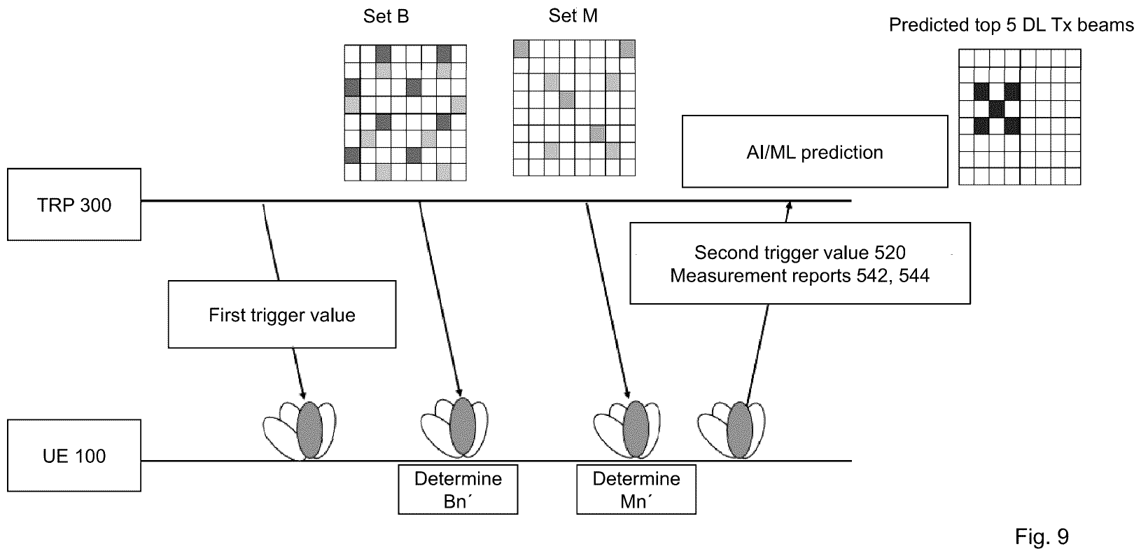

Moreover, FIG. 8 illustrates when the network provides an initial inference and monitoring configuration to the UE 100 as previously described and FIG. 9 further illustrates the example when the UE 100 provides a recommended inference and monitoring configuration to the network. The latter configuration means that the information at the UE 100 relevant for AI/ML model measurements may be used to optimize beam prediction in the communication system 500.

In FIG. 8, the network via in this case a transmission and reception point (TRP) 300 transmits an indication of a first trigger value to the UE 100. Upon reception of the indication of the first trigger value the UE 100 as previously mentioned starts to measure resources in the first set B and the second set M previously configured by the network and transmitted by the TRP 300. The UE 100 may have been configured by the measurement configuration message 510. Based on the measurements the UE 100 derives inference and monitoring measurement reports which are transmitted to the network via the TRP 300. The network processes the information in the inference and monitoring measurement reports associated with the AI/ML model(s) for beam prediction as previously described.

In FIG. 9, the TRP 300 transmits the indication of the first trigger value to the UE 100 as in FIG. 8. The UE 100 may measure recommended resources determined by the UE 100 but within the resources configured by the network. It may be noted that the recommended resources B1′, B2′, M1′, M2′, M3′, Bc′, Mc′ are also illustrated in FIG. 6. In the embodiments, the recommended resources belong to the first set of resources B and/or to the second set of resources M determined by the network.

The UE 100 may determine or select the recommended resources using different types of information in its decision making. In the embodiments, the UE 100 determines a first recommended resource Bn′ in the first set of resources B and a second recommended resource Mn′ in the second set of resources M based on one or more of:

A resource selection algorithm,

A measurement on a resource different to the first resource Bn and the second resource Mn, and

A location of the UE 100, a movement direction of the UE 100, and a speed of the UE 100 which may be denoted side information about the UE 100.

The resource selection algorithm may be a ML algorithm that predicts wide beams, or measurement resources based on side information such as previous CSI reports and link measurements.

Measurement on other resources or different resources may refer to the SSB measurements which are performed periodically, including during the initial access procedure when connecting to the network.

The side information of the UE 100 can also be used for resources selection which is more critical for the beam prediction in the time-domain. Indeed, since the goal is to cope with UE mobility, having side information about its mobility pattern can be used in order to predict where the UE is going, and at which pace, and consequently, select the beams that are relevant for its future location.

It is therefore noted that the recommended resources belong to the first set of resources B or the second set of resources M or to both resource sets if the resources are overlapping as previously explained. This implies that the recommended resources are either used for inference measurements or monitoring measurements. Hence, in the embodiments, the UE 100 measures a first recommended resource Bn′ to obtain a second inference measurement report 542 and measure a second recommended resource Mn′ to obtain a second monitoring measurement report 544. The UE 100 thereafter transmits the second inference measurement report 542 and the second monitoring measurement report 544 to the TRP 300 as shown in FIG. 9.

Also, the recommended resources determined by the UE 100 correspond to beams. Hence, the recommended resources correspond to transmit beams of the second communication device 300, receive beams of the first communication device 100, or beams pairs where each beam pair includes a transmit beam of the second communication device 300 and a receive beam of the first communication device 100.

To inform the network of the measurement of the recommended resources, the UE 100 may transmit a second trigger value 520 for the AI/ML model to the network. The second trigger value 520 indicates the measurement of at least one first recommended resource Bn′ in the first set of resources B and at least one second recommended resource Mn′ in the second set of resources M. Hence, also the second trigger value associates resources to be measured by the UE 100 with a particular trigger value.

A network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access node may be of different classes or types such as e.g., macro eNodeB, home eNodeB or pico base station, based on transmission power and thereby the cell size. The radio network access node may further be a station, which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

A client device herein may be denoted as a user device, a user equipment (UE), a mobile station, an internet of things (IOT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant MAC and PHY interface to the WM. The UE may be configured for communication in 3GPP related LTE, LTE-advanced, 5G wireless systems, such as NR, and their evolutions, as well as in IEEE related Wi-Fi, WiMAX and their evolutions.

Furthermore, any method may be implemented in a computer program, having code means, which when run by processing means causes the processing means to execute the steps (or operations) of the method. The computer program is included in a non-transitory computer readable medium of a computer program product. The non-transitory computer readable medium may include essentially any non-transitory memory, such as previously mentioned a ROM, a PROM, an EPROM, a flash memory, an EEPROM, or a hard disk drive.

Moreover, it should be realized that the first communication device 100 and the second communication device 300 includes the necessary communication capabilities in the form of e.g., functions, means, units, elements, etc., for performing or implementing the embodiments. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the first communication device and the second communication device may include, e.g., one or more instances of a CPU, a processing unit, a processing circuit, a processor, an ASIC, a microprocessor, or other processing logic that may interpret and execute instructions. The expression “processor” may thus represent a processing circuitry including a plurality of processing circuits, such as e.g., any, some or all of the ones mentioned above. The processing circuitry may further perform data processing functions for inputting, outputting, and processing of data including data buffering and device control functions, such as call processing control, user interface control, or the like.

It should be understood that the scope of the embodiments is not limited to the embodiments described above, but also relates to and incorporates all embodiments understood by a person of ordinary skill in the art.

1. A first communication device for a communication system, wherein the first communication device is configured to:
receive a measurement configuration for at least one artificial intelligence/machine learning (AI/ML), model for beam prediction from a second communication device, the measurement configuration indicating a first trigger value for measurement of at least one first resource in a first set of resources and at least one second resource in a second set of resources, wherein the first set of resources is for an inference measurement of the AI/ML model and the second set of resources is for a monitoring measurement of the AI/ML model;
measure the first resource to obtain a first inference measurement report for the AI/ML model; and
measure the second resource to obtain a first monitoring measurement report for the AI/ML model.

2. The first communication device according to claim 1, wherein the measurement configuration further indicates the first resource in the first set of resources and the second resource in the second set of resources.

3. The first communication device according to claim 1, wherein the first set of resources and the second set of resources comprise overlapping resources.

4. The first communication device according to claim 1, wherein the first set of resources corresponds to a first set of beams and the second set of resources corresponds to a second set of beams.

5. The first communication device according to claim 4, wherein the first set of beams and the second set of beams comprise any one of:
transmit beams of the second communication device,
receive beams of the first communication device, and
beams pairs, and each beam pair includes a transmit beam of the second communication device and a receive beam of the first communication device.

6. The first communication device according to claim 1, wherein the first communication device is further configured to:
receive the measurement configuration in a radio resource control (RRC).

7. The first communication device according to claim 1, wherein the first communication device is further configured to:
measure the first resource in the first set of resources and the second resource in the second set of resources upon receiving an indication of the first trigger value.

8. The first communication device according to claim 7, wherein the first communication device is further configured to:
receive the indication of the first trigger value in a downlink control information.

9. The first communication device according to claim 7, wherein the first communication device is further configured to:
receive a new first trigger value in a medium access control (MAC) control element (MAC CE), the new first trigger value indicating measurement of at least one resource different to the first resource in the first set of resources and the second resource in the second set of resources.

10. The first communication device according to claim 1, wherein the first trigger value is given in a bit format.

11. A second communication device for a communication system, wherein the second communication device is configured to:
transmit a measurement configuration for at least one AI/ML model for beam prediction to a first communication device, the measurement configuration indicating a first trigger value for measurement of at least one first resource in a first set of resources and at least one second resource in a second set of resources, wherein the first set of resources is for an inference measurement of the AI/ML model and the second set of resources is for a monitoring measurement of the AI/ML model.

12. The second communication device according to claim 11, wherein the measurement configuration further indicates the first resource in the first set of resources and the second resource in the second set of resources.

13. The second communication device according to claim 11, wherein the first set of resources and the second set of resources comprise overlapping resources.

14. The second communication device according to claim 11, wherein the first set of resources corresponds to a first set of beams and the second set of resources corresponds to a second set of beams.

15. The second communication device according to claim 14, wherein the first set of beams and the second set of beams comprises any one of:
transmit beams of the second communication device,
receive beams of the first communication device, and
beams pairs where each beam pair includes a transmit beam of the second communication device and a receive beam of the first communication device.

16. The second communication device according to claim 11, further configured to:
transmit the measurement configuration in a RRC to the first communication device.

17. The second communication device according to claim 16, further configured to:
transmit an indication of the first trigger value in a DCI to the first communication device.

18. The second communication device according to claim 16, further configured to:
transmit a new first trigger value in a MAC CE to the first communication device, the new first trigger value indicating measurement of at least one resource different to the first resource in the first set of resources and the second resource in the second set of resources.

19. The second communication device according to claim 11, wherein the first trigger value is given in a bit format.

20. A method for a first communication device, the method comprising:
receiving a measurement configuration for at least one AI/ML model for beam prediction from a second communication device, the measurement configuration indicating a first trigger value for measurement of at least one first resource in a first set of resources and at least one second resource in a second set of resources, wherein the first set of resources is for an inference measurement of the AI/ML model and the second set of resources is for a monitoring measurement of the AI/ML model; and
measuring the first resource to obtain a first inference measurement report for the AI/ML model; and
measuring the second resource to obtain a first monitoring measurement report for the AI/ML model.
